(19) United States
(12) Patent Application Publication
(10) Pub. No.: US 2009/0037152 A1
(43) Pub. Date: Feb. 5, 2009

(54) Mapping Fan Noise Across an Hydraulic Plane

(76) Inventors: Maurice Francis Holahan, Lake City, MN (US); Michael Desmond O'Connell, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/830,916

(22) Filed: Jul. 31, 2007

(51) Int. Cl. G06F 17/10; G06G 7/48

(52) U.S. Cl. 703/2; 703/7

(57) ABSTRACT

A method and computer program product is presented to map noise levels onto the hydraulic operating plane. Application of this model has the potential to show which fan is quieter, where, and by how much. It is shown how the technique can be applied to a diverse set of comparisons including speed, diameter, type, model, and multiple fans in combination.

### BACKGROUND OF THE INVENTION

1. Field of the Invention

The present invention generally relates to fans or other cooling devices used to remove heat from a server, computer system, or other electronic device.

2. Description of the Related Art

The acoustic output of fans has become a thermal constraint in cooling of high-end servers. Despite this, thermal designers often fail to fully understand the acoustic consequences of changing the hydraulic operating point of the cooling system design, and fan vendors continue to provide only sparse data from which meaningful projections are impractical.

Accordingly there is a need for an algorithm to map a unit fan sound power measurement onto the entire hydraulic operating plane. Accordingly there is also a need to show how noise surface contours may be generated for different speeds, diameters, and multiple fans in parallel and series in order to determine the fan configuration that will deliver the most flow and pressure at a given noise level constraint.

### SUMMARY OF THE INVENTION

An algorithm is presented to map a set of acoustic sound power measurements taken according to ISO10302, Acoustics—Method for the measurement of airborne noise emitted by small air-moving devices, herein incorporated by reference, for a single operating curve out to the entire hydraulic operating plane. The resulting noise map, expressible as either a noise surface or a two dimensional level line contour map, is then used in a variety of ways. Peaks and valleys indicate off-design stall regions and desirable operating regions respectively, clearly showing the acoustic cost of achieving a specific hydraulic operating point. In addition to showing where a particular device can be most quietly operated, a thermal designer can now identify multiple options for maximizing the cooling potential at a given noise level constraint. A map of the noise contours provides a consistent way to bridge reference unit level fan data to system applications. Examples are shown to demonstrate how the method can be used to enable direct objective comparison between competing fan designs, including device types and different device sizes. The methodology is further extended to allow direct comparison of multiple fans in parallel and series configurations.

This and other features, aspects, and advantages will become better understood with reference to the following description, appended claims, and accompanying drawings.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates flow and noise data for a 120×30 mm high performance mixed flow tubeaxial fan, taken at 3 motor voltages.

FIG. 2 illustrates a noise surface in three dimensions: X: volumetric flow rate (CFM), Y: static pressure (pa), Z: sound power level L_{WA} (bels).

FIG. 3 illustrates level lines of sound power; isobels forming a noise surface.

FIG. 4 illustrates a reference flow curve.

FIG. 5 illustrates a noise signature: reference sound power as a function of effective orifice diameter.

FIG. 6 illustrates isobels at 6.4 bels L_{WA}, for diameters at 75% and 125% of original diameter.

FIG. 7 illustrates isobels at 6.4 bels L_{WA}, for various fan systems: a single fan, and series/parallel combinations of multiple fans.

FIG. 8 illustrates noise difference contours LWA₁−LWA₂ for a 150 mm fan 1 compared to a 120 mm fan 2.

FIGS. 9A and 9B illustrate a Noise difference surface LWA₁−LWA₂, divided into two regions: FIG. 9A where 120 mm fan 2 is quieter, and FIG. 9B where a 150 mm fan 1 frame is quieter.

### DETAILED DESCRIPTION

The primary function of a fan is to produce flow and pressure, and we seek an understanding of how to maximize these outputs within an acoustic constraint in servers and other air-cooled electronics applications. The optimum geometry and resulting net thermal conductance that can be attained from high performance compact heat exchanger depends on the specific heat and conductivity of the gas moving within its passages, the thermal conductivity of the material forming the passages, and more importantly, the volumetric flow and pressure that can be delivered to it. At one extreme, the free-air volumetric flow delivery of an air mover defines the maximum thermodynamic conductance that would be achievable with an infinitely large exchanger. At the other extreme, the shutoff pressure of the air mover bounds the maximum volumetric conductance that can be achieved. Within these limits, the actual operating point of the air mover determines the potential cooling capacity; it fixes the number of channels that can be supported at a particular pressure drop. The availability of flow and pressure is integral to defining the optimum forced-air heat transfer geometry. The parameter space where heat exchanger design optimization, fan delivery, and acoustic output all come into play is the hydraulic operating plane, with volumetric flow rate plotted on the abscissa and static pressure along the ordinate.

A more complete understanding of the acoustic consequences of changing the system's hydraulic design point enables thermal designers to maximize thermal capacity within a particular acoustic output constraint. However, most fan vendors now provide only sparse noise data from which meaningful system projections are impractical. Therefore a methodology is presented in order to relate unit level fan noise output to the useful system airflow output. It is also shown how standardizing such an approach might lead to many economies in design and test.

The basic design levers available to the application engineer are: select device type, adjust speed, increase or decrease sizes, utilize multiple devices in combination, and select different models and or manufactures within the same device type. For selection of device type, the choices for electronics cooling are primarily among tubeaxial, forward curved centrifugal, backward curved centrifugal, and mixed flow devices. For variation of impeller rotational speed; the use of DC brushless motors and controllers usually offers a continuous range up to some motor power limit. For variation of size (diameter), an array of industry standardized form factors is available and increasing over time. Multiple devices are arranged in series or parallel or some combination thereof. Manufacturers generally offer different models within the same form factor, often with various cost-performance tradeoffs.

Investigation of all of the acoustic ramifications presented by the large numbers of variables present in thermal-acoustic optimization problems is a daunting task. However, prior work has shown how simplification of the problem is made possible using principles of similitude. Previous work presented non-dimensional analysis for fan hydraulic performance:

flow coefficient φ= [symbol] ND³ (1)

pressure coefficient ψ=P/η*N²D² (2)

Where [symbol] is a volumetric flow rate, N is a rotational speed, and D is the blade diameter. For the purposes of the present invention, air may be treated as incompressible. For sound power L_{W} (decibels) and specific sound power level L_{Ws}, at the point of rating previous work provides these acoustic relationships:

L_{W}=L_{Ws}+10 log Q+20 log Pₛ (3)

L_{W}=L_{Ws}+50 log N+70 log D (4)

Previous work also listed the types of similarity, (geometric, kinematic, and dynamic) for strict nondimensionality analysis, and discussed the conditions under which real fans deviate from the assumptions, and the pitfalls encountered in misapplying or overextending empirical findings. Three principle noise generating mechanisms are identified in the previous work: aerodynamic, electromagnetic, and mechanical.

Previous work also summarized historical developments in the study of noise from small fans, including the development of an acoustically transparent plenum to hydraulically load a device under test, and proposed a predictive model for the spectral content. This work has been extend to blowers of varying impeller width, and also plotted a noise surface against dimensionless flow and the impeller aspect ratio. The present invention however develops a different type of noise surface for sound power levels over the hydraulic operating plane.

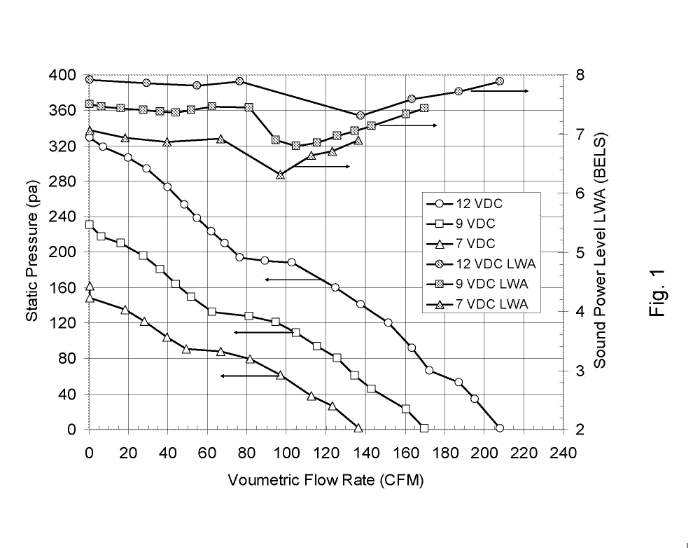

A set of flow and noise measurements, collected with the plenum described in ISO 10302, is shown in FIG. 1 for a 120×38 mm mixed flow fan at three motor speed (voltage) settings. The curves show pressure on the left ordinate and sound power on the right ordinate, paired against flow rate on a common abscissa. Variation of noise along the flow curve is apparent, but interpolation between levels is difficult. The curves for pressure-flow can be collapsed into a single curve in non-dimensional variables ψ, φ. Similarly, the sound power curves can be collapsed into a single curve of non-dimensional sound power coefficient Λ as a function of φ. However, when cast in these forms, a level of abstraction is introduced which tends to be a barrier to designers seeking direct comparisons on the hydraulic plane.

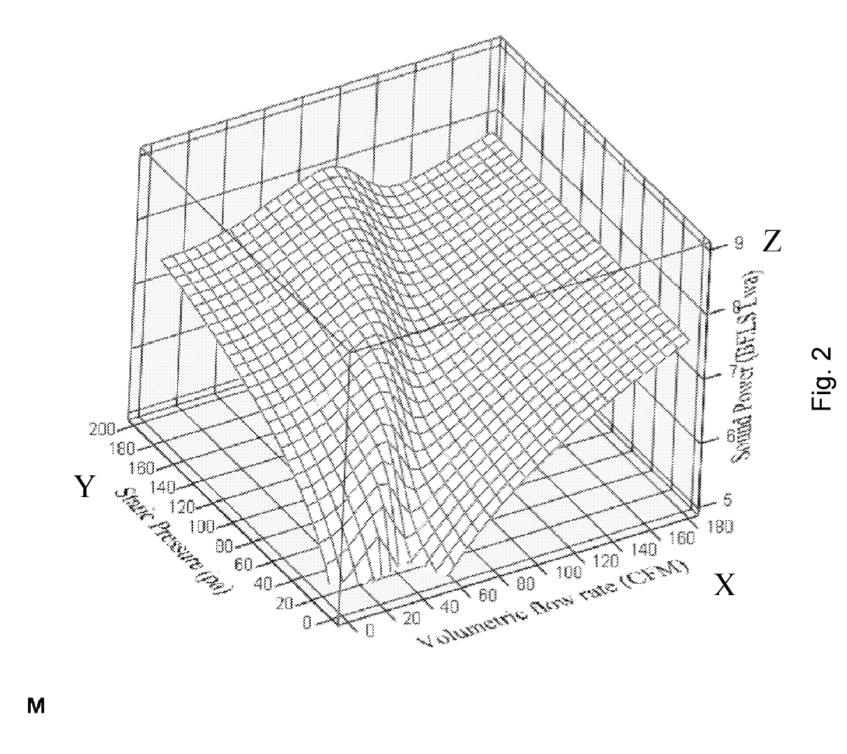

A three-dimensional noise surface can be projected over the pressure-flow plane as shown in FIG. 2. This is useful to understand qualitative trends, but it is difficult to make quantitative comparisons with this type of representation. An embodiment of the present invention seeks a more intuitive, direct mapping which will aid the interpolation of noise curves as a function of rotor speed.

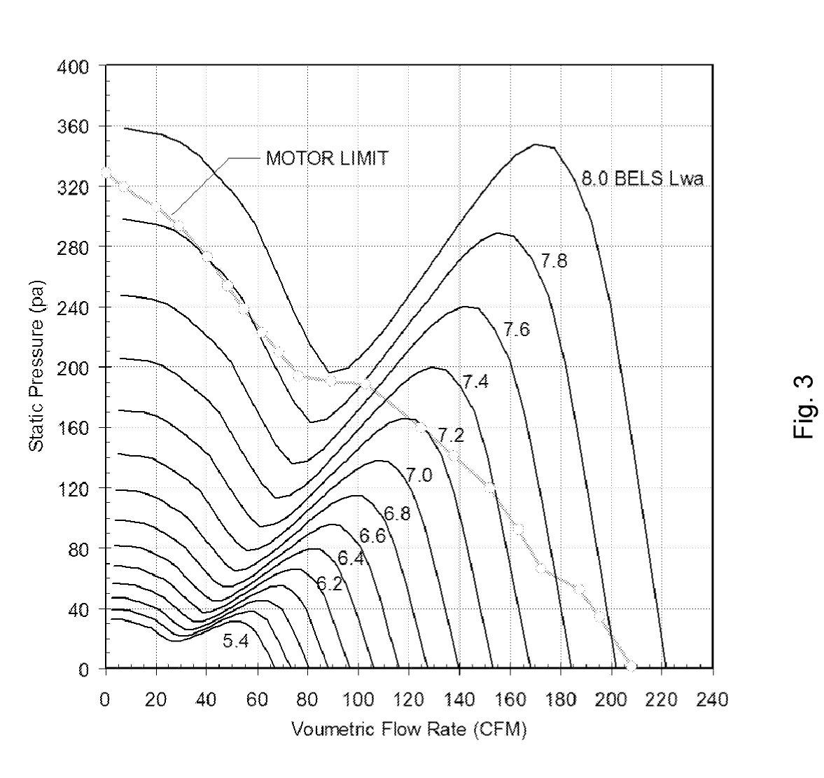

For engineering purposes, the existence of a function of two variables (in this case sound power output as a function of volumetric flow rate and static pressure) may be more thoroughly explored by means of a two-dimensional contour, or level-line plot, as commonly used in topographic maps of terrain. Lines of constant noise level, termed isobels, may be drawn by connecting all points where the sound power reaches the same level in the operating plane. As in all contour mapping, the gradient of the noise is perpendicular to the tangent of the contour line, and the relative spacing between uniformly incremented lines is indicative of the magnitude of the gradient. A 2-D contour map provides most of the visual cues of the 3-D surface, with the advantage that numerical values can be read directly from the plot. FIG. 3 shows an example of a 2-D contour plot of sound power level lines overlaid on the hydraulic plane with isobels spaced at two decibel intervals. Full contours are mapped up to a level of 8.0 bels, however, the speed of this particular device is limited to the flow curve indicated by “MOTOR LIMIT”. Projections above this curve show noise levels that would be attained with a more powerful motor.

At least two methods can be employed to produce the contours. The first method is to develop a noise model function L_{WA}( [symbol] P) and apply it over an array of uniformly spaced points in the ( [symbol] P) plane to generate a full noise surface as was shown in FIG. 2. The contour lines can then be calculated using commercially available software. This method is more difficult to standardize because of potential differences in the behavior of the contouring algorithm. It requires a large number of points to be calculated to obtain a smooth set of contours. A second method is to develop an algorithm to directly calculate the X, Y position of an explicitly defined isobel. This method limits the calculation requirements to only those of interest, and with the flexibility to show single contours, it facilitates direct comparison of isobels for different speeds, diameters, device types, and multiple fans in parallel and series combinations on a common hydraulic plane. Explicit generation of an isobel line is the preferred method as it is a step closer to the physics of the problem, reduces fitting errors, allows a minimum number of points to capture the noise signature, and is more amenable to standardization.

Model Development

Algorithm for generation of explicit isobels on the hydraulic plane

Before mapping, a data collection process must be undertaken to obtain a characteristic flow and noise “signature” which encompasses all points of rating from shut-off to free air. Once this data is obtained, the mapping solution reduces to using the physics-based relationships defined in the prior work identified above.

Data Acquisition Procedure

Airflow

The airflow is measured on a flow test bench according to ANSI/AMCA Standard 210-99, Laboratory Methods of Testing Fans for Aerodynamic Performance Rating, herein incorporated by reference. The data for each point of rating includes volumetric flow rate, static pressure, and impeller rotation speed, and fan inlet air density. The pressure range covers shutoff to free air with uniformly distributed points sufficient in number to resolve the knee of the curves. A set of twenty points is normally adequate. The data is taken at a single fixed motor voltage or speed control setting.

Noise

The fan is then mounted on a noise test plenum to measure sound power following ISO 10302. The plenum is an acoustically transparent enclosure having an adjustable exhaust aperture to control the static pressure load. The measured data includes inlet air density and the sound power and aperture open area at each point. A set of approximately twenty points is taken to resolve the noise signature. The plenum pressure can be measured directly, but because of the possibility of operation at two flow points for the same pressure with some device curves, prior investigators have recommended flow-bench based measurement of the plenum to correlate pressure drop with slider open area as a known-function of slider position.

Reference Flow Curve Model

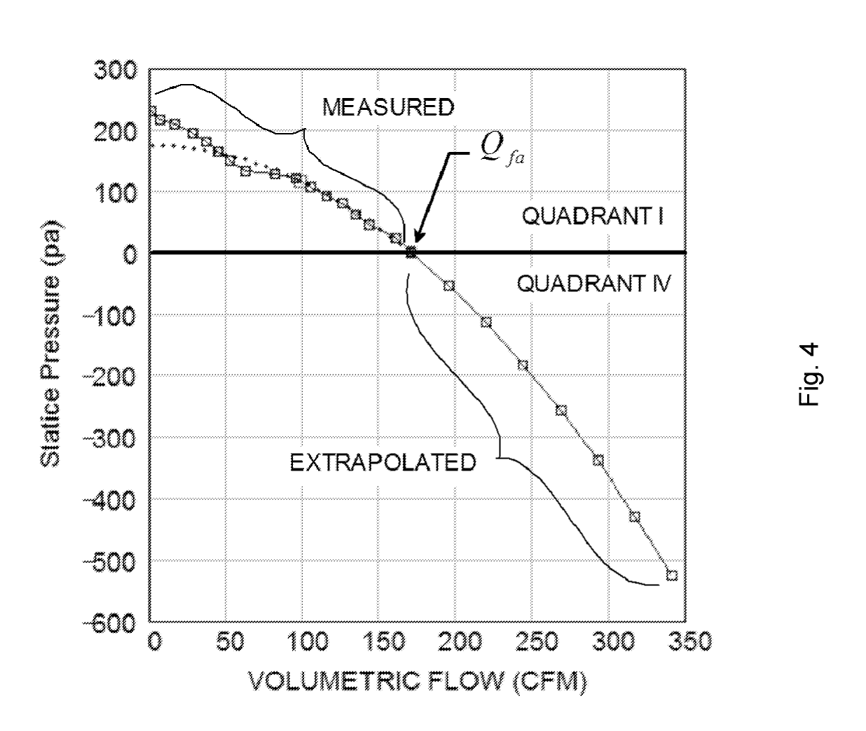

A curve-fit model for the airflow performance curve is developed from the measured data as follows. The vector of pressure points is fit against the vector of flow points using a cubic spline routine to determine the second derivative coefficients for the interpolation model function P( [symbol] ) to yield a reference static pressure at any given reference flow rate 0< [symbol] < [symbol] ₐ. The set of flow points is then extrapolated into quadrant IV of the pressure-flow plane, in the region Pₛ<0 [symbol] ₐ< [symbol] < [symbol] ₐ, to enable a numerical solution scheme to extrapolate to flows higher than the original [symbol] ₐ. The curve is extended using a fan model of the form P=A−BQ² where coefficient B is determined from a pair of points, pt1{Q₁, P₁} near the knee, and pt2{Q₂, P₂} near free air, with B=(P₂−P₁)/(Q₁²−Q₂²) and A=P₁+BQ₁², as shown in FIG. 4.

Reference Noise Curve

Following eqs. 3 and 4, a reference specific A-weighted sound power L_{WASi} is calculated for each of the measured noise points L_{WAi} by solving L_{WASi}=L_{WAi}−5 log(RPMᵢ). A model function must be developed to fit the specific A-weighted sound power to the point of rating. A logical choice is to use the flow coefficient φ, however, when attempting to extrapolate to a different operating point, the speed required to determine φ according to eq. 1 may not be immediately known. To capture both flow and pressure, one might make use the constant of proportionality k=p/Q², which uniquely determines the point of rating. However, k tends to infinity at shut-off and goes to zero at free-air; it typically spans many orders of magnitude and is difficult to curve fit against. To resolve this, an embodiment of the present method utilizes an effective orifice diameter DO defined by:

$${D}_{o} = {[ \frac{8 ρ}{π} ( \frac{P t}{} ) ]}^{\frac{1}{4}} \qquad ( 5 )$$

where Pₜ=Pₛ+Pᵥ is the fan total pressure with velocity pressure

$$Pv = \frac{ρ}{2} {V}^{2} ,$$

velocity V is determined by the flow over an area swept by the blade tip diameter. The effective orifice diameter thus ranges from 0≦D_{O}≦Dₜᵢₚ. The effective orifice diameter D_{O} can be made dimensionless by dividing it by tip Dₜᵢₚ. It then becomes the fourth root of the throttling coefficient τ:

$${τ}^{\frac{1}{4}} = {D}_{o} / {D}_{tip} ,$$

and ranges from

$$0 \leq \frac{{D}_{o}}{{D}_{tip}} \leq 1.$$

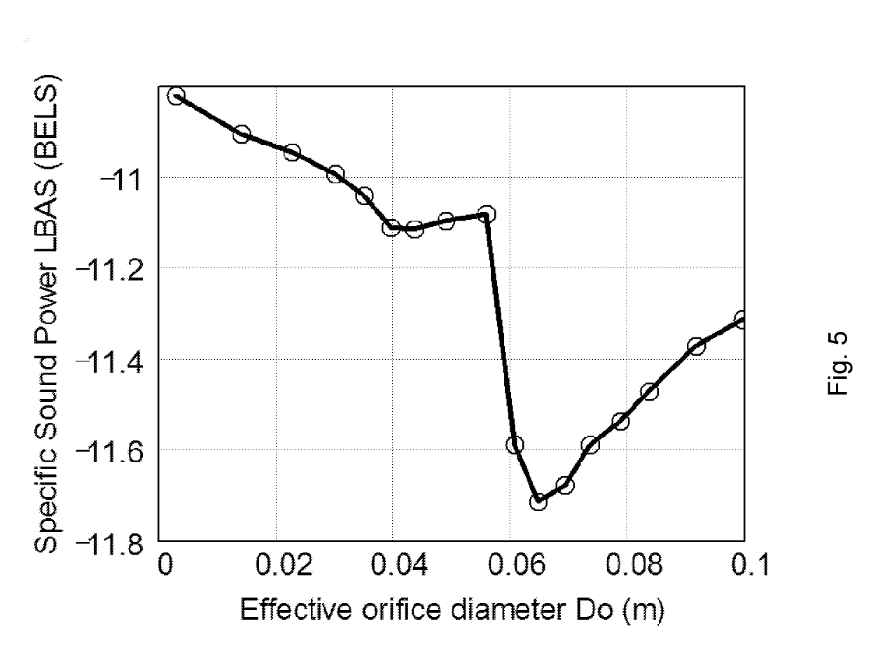

However, staying with the form of a dimensional effective orifice diameter permits more physically intuitive analog, the most immediate example of which is the test plenum aperture. The specific noise reference level is fit against the orifice diameter using the same cubic spline curve fitting routine as used for the flow curve fit. Equipped with this model, it is now possible to infer a reference noise level for a given target flow-pressure point. A noise curve for the example fan appears in FIG. 5. Note the large increase in sound power in the vicinity D_{O}≈0.06 (m) corresponding to a region of transition into stall.

Noise at Hydraulic Point Algorithm

An algorithm to estimate the noise level at a given flow and pressure point follows:

A spline interpolation routine is used to form continuous functions of the measured reference data: L_{WAS(Do)}, [symbol] D_{O}), and N( [symbol] ).

The equivalent orifice diameter D_{O} at the target ( [symbol] P) operating point is calculated directly from eq. 5.

A reference specific sound power level L_{WAS}_{₁} and reference flow rate [symbol] is evaluated by interpolating L_{WAS(Do)} and [symbol] D_{O}) respectively at D_{O}.

A reference flow rate [symbol] is calculated by interpolating [symbol] D_{O}) at D_{O}.

The fan speed required to achieve the target ( [symbol] P) operating point is then, by eq. 1:

$${N}_{2} = \frac{}{} N$$

where N is a reference speed found from N( [symbol] ). The sound power at the target ( [symbol] P) is then given by

L_{WA}_{₂}=L_{WAS}+5 log(N₂)

Explicit Isobel Algorithm

The free-air flow rate [symbol] _{fa}_{₂} for the target sound level L_{WA} is estimated as follows:

The speed N₂ required to achieve the target sound level L_{WA} at the free air point is given by rearranging eq. 4:

$${N}_{2} = {10}^{[ log ( {N}_{1} ) * \frac{{L}_{WA ( fa )} - {L}_{WA}}{5} ]}$$

where N₁ is a free air RPM, and L_{WA(fa)} is the free air noise level, both from the reference data curve.

The free air volumetric flow rate [symbol] _{fa}_{₂} is then determined by scaling

$${{fa}_{2}}_{} = \frac{{N}_{3}}{{N}_{1}} {fa}_{1}$$

by eq. 1. A vector of flow point is established by [symbol] = [symbol] _{fa}_{₂}/Insteps where nsteps is the desired number of flow points. A range of 20≦nsteps≦30 will produce a smooth contour.

For each flow point [symbol] , an iterative routine is used to solve for the static pressure Pᵢ that will generate the target noise level L_{WA(targ)}:

An initial guess is made for static pressure Pᵢ.

The A-weighted sound power level is calculated for the ( [symbol] , Pᵢ) pair using the noise model described above.

The guess value of Pᵢ is adjusted until the error quantity L_{WA(Q}_{ᵢ}_{, P}_{ᵢ})−L_{WA(targ)} falls below a remainder criteria.

The above calculation is looped through nsteps to produce a single isobel, within an outer loop which increments to the next isobel level, resulting in a full set of isobels as shown in FIG. 3.

Applications of the Model

Noise Surface Extension to Different Diameters

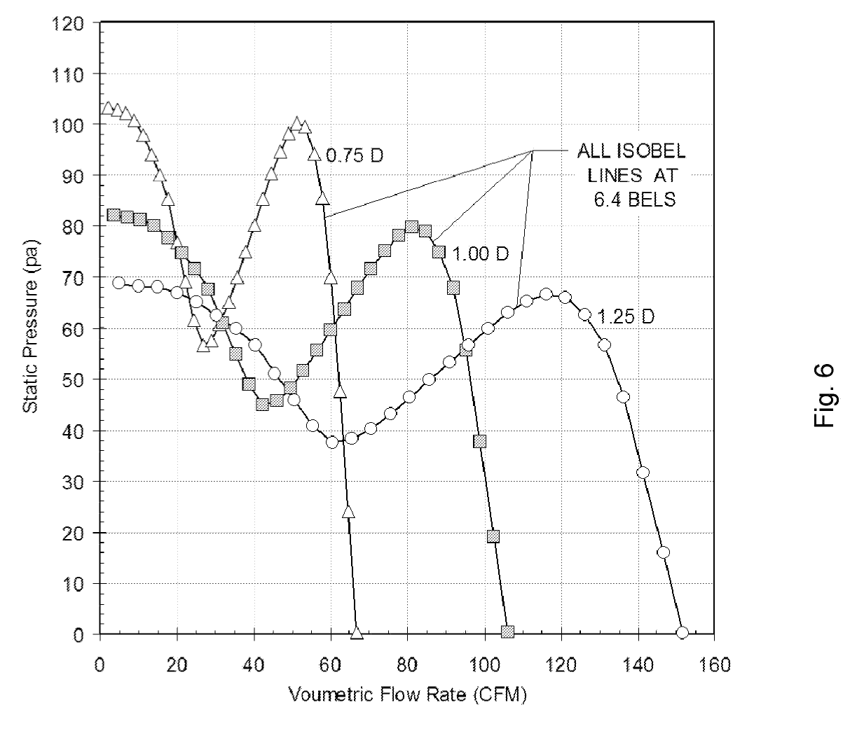

The foregoing model may be used to predict the noise level of homologous fans of different diameters, as shown in FIG. 6, where the diameter has been scaled to 75% and 125% of the original (1.00 D) with scaling by fan law eqs. 1-4. The example isobel lines show the flow and pressure that each of these fan sizes would attain at the same sound power output of 6.4 BELS. It is clear that if the hydraulic requirement is in the 50 CFM range, the smaller (0.75 D) fan produces almost 2× the pressure at the same noise level, but if a flow of 80 CFM is required, the original (1.00 D) fan delivers the higher pressure.

Noise Surface Extension to Multiple Fans

Multiple fans in combination: Multiple fan systems are an important means of providing cooling redundancy. The strategy for projecting the acoustic performance of multiple fans is: determine the point of rating at which each fan will operate as a unit level fan, then take into account the effect of multiple fans. Reductions in flow and pressure delivery due to non-ideal system effects must be taken into account by applying degradation factors to the ideal models. For example, the present analysis will describe combinations of fans that have the same number of fans in parallel at each series stage. Let np be the number of fans in parallel in each stage, and let there be ns stages of fans placed in series. The total number of fans in the system is then nfans=ns*np.

The total noise output of the system is taken as the logarithmic sum of the individual fans each operating at the same point of rating, with the implicit assumption that no noise interaction exists between the two fan outputs.

L_{WA(sys)}=L_{WA(fan)}+log(ns*np)(bels) (6)

Thus, two fans produce a system that is 0.3 bels or 3 decibels higher than a unit fan, four fans are 0.6 bels higher, and so on.

Fans in parallel and series: Fans in an ideal parallel arrangement output a net flow rate that is the linear sum of unit level flows at the same static pressure as a unit fan: [symbol] _{sys}=np* [symbol] _{fan}. Fans in an ideal series arrangement output linearly additive static pressures at the same flow rate as a unit fan: P_{sys}=np*P_{fan}.

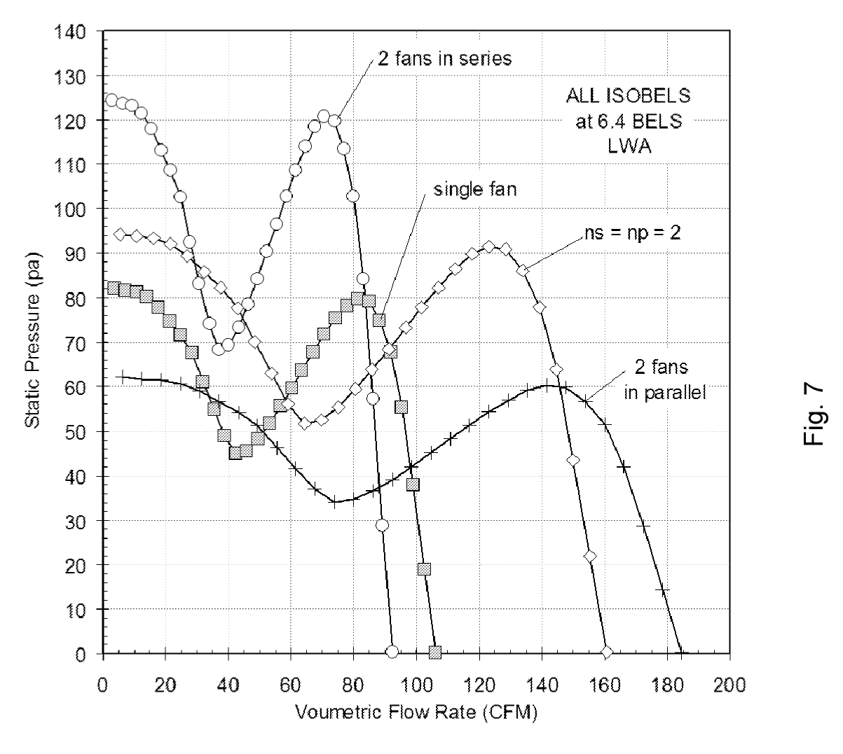

FIG. 7 shows that if hydraulic requirements were for 90 CFM and 70 pascals, a single fan at higher speed would match the noise output of a system of 4 slower fans arranged in two series stages of 2 fans in parallel each. If the operating point is 120 CFM, 90 pa, the ns=np=2 fan system offers the quietest noise level. At a system requirement of 70 CFM, two fans in series clearly offers a higher pressure capacity (120 pa) than single or parallel fan combinations which manage only 70 pa at the same noise level of 6.4 BELS.

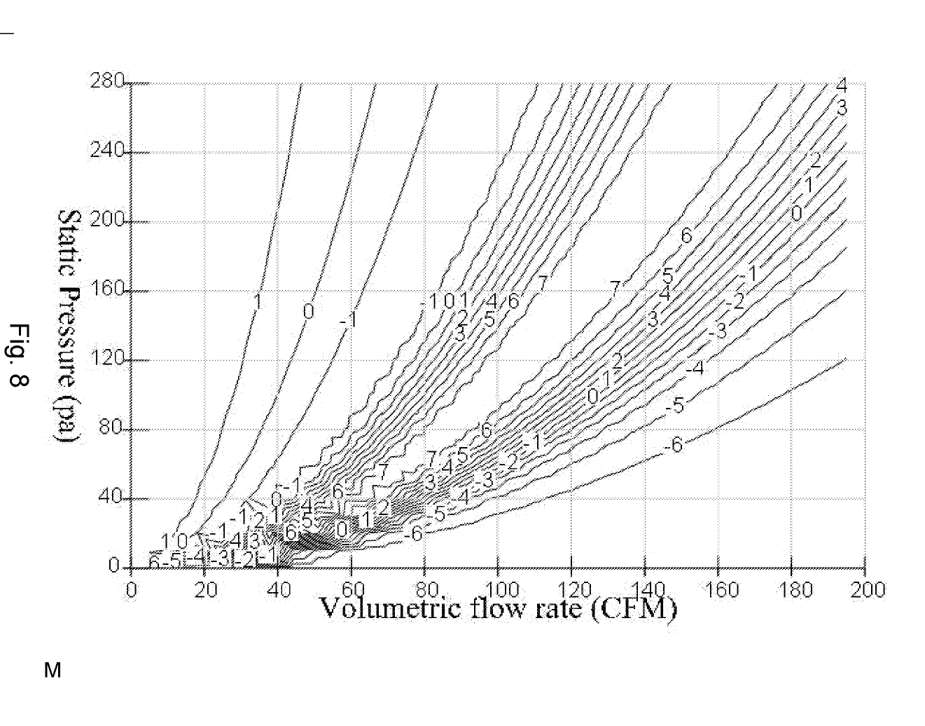

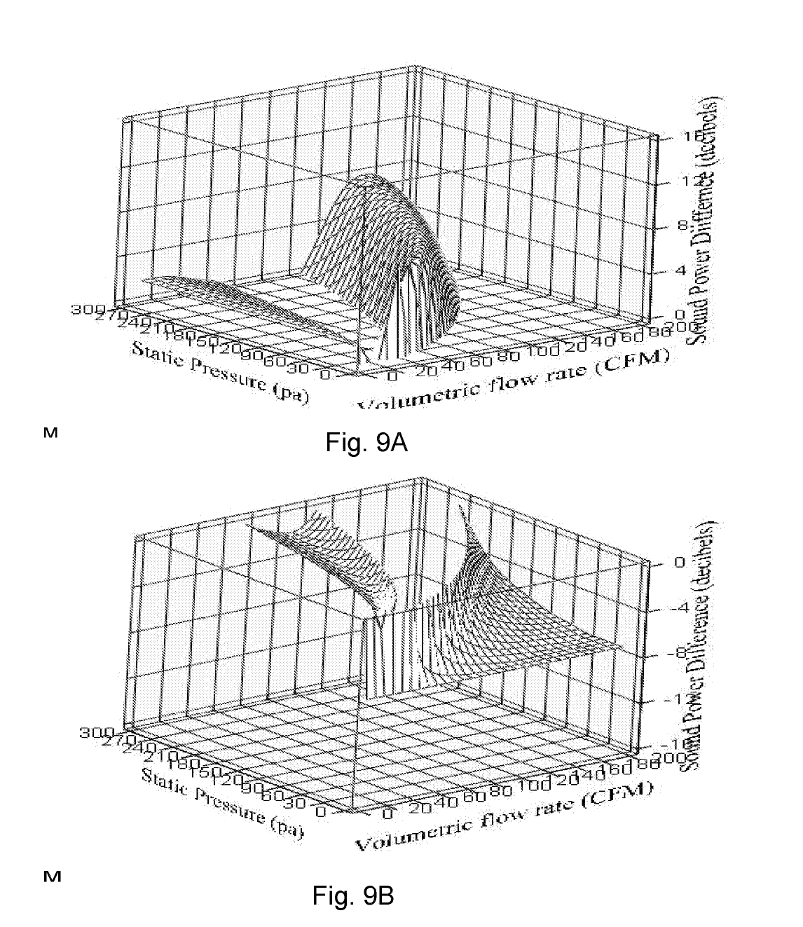

Comparison of fan options by surface subtraction. Much can be learned from side-by-side comparison of noise contour plots, to explore such basic questions as whether the lowest noise for a given hydraulic operating point target might be achieved by any of the following options: changing the speed of a single fan, changing to a larger fan, changing to multiple fans in series or in parallel, changing to a quieter model of the same size fan, or changing to an entirely different device type. In order to show precisely how any pair of the above fan options differ in noise output in a quantified manner, simply subtract the LWA values at the same flow-pressure points to produce a noise-difference map over the hydraulic plane, as shown in FIG. 8 in contour form, and FIGS. 9A and 9B in surface profile form. These example maps show that a 25% larger homologous fan 1 is up to 7-8 dB noisier in a specified higher pressure region, and 6 dB quieter in a lower pressure region. In other words the side by side explicit Isobel mappings may be utilized to determine which fan configuration within an electronic system will deliver the most flow and pressure at a given noise level constraint, and the noise difference maps may be utilized to determine which fan configuration will produce the lowest noise level at a given hydraulic operating target.

This method to determine which fan configuration within an electronic system will deliver the most flow and pressure at a given noise level constraint, with reference to the above detailed description, generally comprises the steps of: generating a noise contour plot for a first fan configuration; generating a noise contour plot for a second fan configuration; generating a noise-difference map over a hydraulic plane by subtracting the sound power level values of the first fan configuration from the sound power level values of the second fan configuration at similar flow-pressure points; identifying an hydraulic operating target for the electronic system, and; selecting either the first fan configuration or the second fan configuration to be utilized in the electronic system.

The step of selecting either the first fan configuration or the second fan configuration may be completed by either determining which configuration results in the lowest noise at the hydraulic operating target or determining which configuration results in the greatest flow rate and pressure delivery at a specified noise target.

In a particular embodiment of the invention, the step of generating the noise contour plots involve obtaining characteristic flow data and noise level data for the first fan configuration and the second fan configuration. In another embodiment this step involves fitting a reference noise curve. In a preferred embodiment the step of fitting the reference noise curve at least involves utilizing a hydraulic load effective orifice diameter. In yet another embodiment the step of generating a noise contour plot involves a method of estimating the noise level at a given flow point and pressure point comprising the steps of: determining a specific a-weighted sound power level as a function of the effective orifice diameter; determining a reference volumetric flow rate as a function of the load point effective orifice diameter, and; determining a rotational speed as a function of the volumetric flow rate ratio. In another embodiment the method of estimating the noise level at a given flow point and pressure point further comprises the steps of: determining a orifice diameter at the hydraulic operating target; determining the reference sound power level and the flow rate by interpolating the specific a-weighted sound power level and the volumetric flow rate at the orifice diameter; determining a fan speed required to achieve the hydraulic operating target, and; determining the sound power corresponding to the fan speed.

In yet another embodiment of the invention generating the noise contour plot involves a method of determining an isobel in the hydraulic plane comprising the steps of: determining a free air volumetric flow rate for a target noise level, and determining a static pressure that generates the target noise level. In another embodiment the step of determining a free air volumetric flow rate further comprises the step of: determining a rotational speed required to achieve the target noise level at the free air point. In yet another embodiment the step of determining a free air volumetric flow rate further comprises the step of: determining a plurality of volumetric flow rate values. In another embodiment the step of determining a free air volumetric flow rate further comprises the step of: determining a static pressure for each of the plurality of volumetric flow rate values that generative the target noise level. In yet another embodiment the step of determining a static pressure for each of the plurality of volumetric flow rate values that generative the target noise level further comprises the steps of: estimating a initial static pressure value for each of the plurality of volumetric flow rate values; determining a a-weighted sound power value for each volumetric flow rate value and corresponding initial static pressure value, and; adjusting the initial static pressure value until an error quantity is below a remainder criteria.

By employing these mapping procedures over a sufficient range of fan types, sizes, and combinations, it is possible to assemble an overall picture of the minimum noise levels required to reach specific hydraulic operating targets. Such a map reveals the minimum acoustic consequences of achieving hydraulic design points. The volumetric consumption of each fan option may be over-plotted to show the acoustic benefit of allowing more space in a system design.

The accompanying figures and this description depicted and described embodiments of the present invention, and features and components thereof. Those skilled in the art will appreciate that any particular program nomenclature used in this description was merely for convenience, and thus the invention should not be limited to use solely in any specific application identified and/or implied by such nomenclature.

The invention claimed is:

1. A method for determining which fan configuration within an electronic system will deliver the most flow and pressure at a given noise level constraint, or which fan configuration will deliver the lowest noise level at a given hydraulic constraint, comprising the steps of:
generating a noise contour plot for a first fan configuration;
generating a noise contour plot for a second fan configuration;
generating a noise-difference map over a hydraulic plane by subtracting the sound power level values of the first fan configuration from the sound power level values of the second fan configuration at similar flow-pressure points;
generating explicit individual isobel curves over the hydraulic plane for each fan configuration.
identifying an hydraulic operating target for the electronic system, and;
selecting either the first fan configuration or the second fan configuration to be utilized in the electronic system.

2. The method of claim 1 wherein the step of selecting either the first fan configuration or the second fan configuration further comprises the step of:
determining which configuration results in the lowest noise at the hydraulic operating target.

3. The method of claim 1 wherein the step of selecting either the first fan configuration or the second fan configuration further comprises the step of:
determining which configuration results in the greatest flow rate and pressure delivery at a sound power target.

4. The method of claim 1 wherein the step of generating the noise contour plots involves obtaining characteristic flow data and noise level data for the first fan configuration and the second fan configuration.

5. The method of claim 4 wherein the step of generating the noise contour plots also involves fitting a reference noise curve.

6. The method of claim 5 wherein fitting the reference noise curve at least involves utilizing a hydraulic load effective orifice diameter.

7. The method of claim 6 wherein generating the noise contour plots involve a method of estimating the noise level at a given flow point and pressure point comprising the steps of:
determining a specific a-weighted sound power level as a function of the hydraulic load effective orifice diameter;
determining a volumetric flow rate as a function of the effective orifice diameter, and;
determining a rotational speed as a function of the volumetric flow rate.

8. The method of claim 7 wherein generating the noise contour plots involve a method of estimating the noise level at a given flow point and pressure point further comprising the steps of:
determining a effective orifice diameter at the hydraulic operating target;
determining the reference sound power level and reference flow rate by interpolating the specific a-weighted sound power level and the reference volumetric flow rate at the orifice diameter;
determining a fan speed required to achieve the hydraulic operating target, and;
determining the sound power corresponding to the fan speed.

9. The method of claim 6 wherein generating the noise contour plots involve a method of determining an explicit isobel in the hydraulic plane comprising the steps of:
determining a free air volumetric flow rate for a target noise level, and determining a static pressure that generates the target noise level.

10. The method of claim 9 wherein the step of determining the free air volumetric flow rate further comprises the step of:
determining a rotational speed required to achieve the target noise level at the free air point.

11. The method of claim 10 wherein the step of determining the free air volumetric flow rate further comprises the step of:
determining a plurality of volumetric flow rate values.

12. The method of claim 11 wherein the step of determining the free air volumetric flow rate further comprises the step of:
determining a static pressure for each of the plurality of volumetric flow rate values that generative the target noise level.

13. The method of claim 12 wherein the step of determining the static pressure for each of the plurality of volumetric flow rate values that generate the target noise level further comprises the steps of:
estimating an initial static pressure value for each of the plurality of volumetric flow rate values;
determining an a-weighted sound power value for each volumetric flow rate value and corresponding initial static pressure value, and;
adjusting the initial static pressure value until an error quantity is below a remainder criteria.

14. A computer system comprising a selected fan configuration having been selected by a process comprising the steps of:
generating a noise contour plot for a first fan configuration;
generating a noise contour plot for a second fan configuration;
generating a noise-difference map over a hydraulic plane by subtracting the sound power level values of the first fan configuration from the sound power level values of the second fan configuration at similar flow-pressure points;
identifying an hydraulic operating target for the electronic system, and;
selecting either the first fan configuration or the second fan configuration to be utilized in the electronic system.

15. The computer system of claim 14 wherein the process step of selecting either the first fan configuration or the second fan configuration further comprises the step of:
determining which configuration results in the lowest noise at the hydraulic operating target.

16. The computer system of claim 14 wherein the process step of selecting either the first fan configuration or the second fan configuration further comprises the step of:
determining which configuration results in the greatest flow rate at a specific sound power level target.

17. The computer system of claim 14 wherein the step of generating the noise contour plots involves obtaining characteristic flow data and noise level data for the first fan configuration and the second fan configuration.

18. The computer system of claim 17 wherein the step of generating the noise contour plots also involves fitting a reference noise curve.

19. The computer system of claim 18 wherein fitting the reference noise curve at least involves utilizing an effective orifice diameter.

20. The computer system of claim 19 wherein the step of generating the noise contour plots further comprises a method of estimating the noise level at a given flow point and pressure point comprising the steps of:
determining a specific a-weighted sound power level as a function of a load point effective orifice diameter;
determining a reference volumetric flow rate as a function of the effective orifice diameter, and;
determining a rotational speed as a function of the volumetric flow rate ratio.

21. The computer system of claim 20 wherein the step of generating the noise contour plots further comprises a method of estimating the noise level at a given flow point and pressure point comprising the steps of:
determining a orifice diameter at the hydraulic operating target;
determining the reference sound power level and the flow rate by interpolating the specific a-weighted sound power level and the volumetric flow rate at the orifice diameter;
determining a fan speed required to achieve the hydraulic operating target, and;
determining the sound power corresponding to the fan speed.

22. The computer system of claim 19 wherein the process step of generating the noise contour plots involve a method of determining a isobel in the hydraulic plane comprising the steps of:
determining a free air volumetric flow rate for a target noise level, and
determining a static pressure that generate the target noise level.

23. The computer system of claim 22 wherein the step of determining the free air volumetric flow rate further comprises the step of:
determining a rotational speed required to achieve the target noise level at the free air point.

24. The computer system of claim 23 wherein the step of determining the free air volumetric flow rate further comprises the step of:
determining a plurality of volumetric flow rate values.

25. The computer system of claim 24 wherein the step of determining the free air volumetric flow rate further comprises the step of:
determining a static pressure for each of the plurality of volumetric flow rate values that generates the target noise level.

26. The computer system of claim 25 wherein the step of determining the static pressure for each of the plurality of volumetric flow rate values that generates the target noise level further comprises the steps of:
estimating a initial static pressure value for each of the plurality of volumetric flow rate values.
